(19) United States
(12) Patent Application Publication
(10) Pub. No.: US 2010/0046504 A1
(43) Pub. Date: Feb. 25, 2010

(54) AUDIO COMMUNICATIONS SYSTEM USING NETWORKING PROTOCOLS

(75) Inventor: Adam Hill, Birmingham (GB)

Correspondence Address: KNOBBE MARTENS OLSON & BEAR LLP, 2040 MAIN STREET, FOURTEENTH FLOOR, IRVINE, CA, 92614, US

(73) Assignee: VOIPEX LIMITED, Ipswich (GB)

(21) Appl. No.: 12/516,037

(22) PCT Filed: Oct. 30, 2007
(86) PCT No.: PCT/GB2007/004132

§ 371 Date: Sep. 22, 2009

(30) Foreign Application Priority Data
Nov. 22, 2006 (GB) 0623229.2

(51) Int. Cl. H04L 12/66

(52) U.S. Cl. 370/352

(57) ABSTRACT

Methods for providing improvement in Voice-over-IP communication systems, and hardware for implementing the methods, are disclosed. A first aspect provides a method of improving on the efficiency of RTP used to transport VoIP voice calls by reducing the overhead of second and subsequent calls on a link to almost zero using trunking. A second aspect uses bandwidth awareness to compress RTP payload data captured from the network. This involves capturing G.711 encoded RTP data directly from the network ( as opposed to at source ) and transcoding that data in such a way as to take account of the available bandwidth on an outbound link. A third aspect uses dynamic and transparent packet fragmentation and reassembly based on RTP interval to reduce VoIP latency and jitter. A fourth aspect uses dynamic re-writing of SIP messages to provides automatic fail-over and load balancing of SIP servers. This involves capturing SIP call set-up messages and re-writing and duplicating them to direct them to multiple servers. The response is monitored to determine which server responds most quickly and allowing only that reply back to the source device. A fifth aspect provides dynamic sizing of trunk payload packets. Given that the above scheme has been set up on a link, it is trivial for the receiving trunk device to determine if the received packets are too big or small, and to signal the transmitter to adjust its payload size accordingly.

This invention relates to communications systems that use networking protocols to carry encoded audio signals between remote computers or dedicated devices. It has particular, but not exclusive, application to communications systems in which the routable networking protocol is the Internet protocol—so-called “voice-over-IP” (VoIP) systems.

The widespread adoption of high-speed Internet connections has led to a rapid adoption of VoIP as an alternative to use of the PSTN to carry voice telephone calls. However, the infrastructure that carries VoIP is not optimised to carry data with the low latency, low jitter and consistently low delay required to support a high-quality telephone call. Nor does that infrastructure carry data in a manner that renders it secure and private. Therefore, successful implementation of VoIP communications systems presents a significant technical challenge.

From a first aspect, the invention provides a method of transmitting speech data between computing devices using networking protocols comprising: a. at an encoder: i. identifying speech data packets in a data stream, ii. identifying one or more contexts for speech data packets, iii. sending to a decoder a packet that identifies the context and the information common to the context, iv. for each packet is a context, transforming the packet by removing from it information that is common to the context and adding to it an identifier of the context, and v. sending the transformed packet to a decoder; b. at a decoder: i. receiving a transformed packet and identifying its context, and ii. transforming the packet by adding to it information that is common to the context and removing from it the identifier of the context.

This method allows a significant reduction in the amount of non-payload data that must be transferred across the network link to support transmission of the speech data.

The method has particular, but not exclusive, application in cases where the speech data packets are in accordance with the real-time transport protocol (RTP).

A context may be defined by a unique combination of one or more of a source address, a source port, a destination address, a destination port and a RTP SSRC. A new context is typically created when a packet is to be transmitted that does not belong to an existing context. Following creation of a new context, data specifying the context may be sent from the encoder to the decoder. To ensure that the data can be decoded, speech packets may be sent from the encoder to the decoder without transformation until an acknowledgement of the data specifying the context is received from the decoder. A context can be freed when no packet has been transmitted in the context for a predetermined period of time.

Typically, a context is identified by a numerical context ID. This is convenient because the transformed packet may include a context flags field in which when bit n is set the transformed packet contains RTP payload data corresponding to context n. Thus, the transformed packets may contain compressed speech data in a plurality of contexts.

From a second aspect, the invention provides a method of transmitting speech data between computing devices using networking protocols comprising, at an encoder, capturing uncompressed encoded speech data directly from the network and transcoding that data in such a way as to take account of the available bandwidth on an outbound link prior to sending it to a decoder.

This allows the bandwidth allocated to each call to be varied in response to variations in the bandwidth of a network link. This allows a call to be transmitted with higher fidelity during times of low usage, during which bandwidth might otherwise go unused. The effect of transcoding may be that the speech data does not need to be transcoded again at the decoder

Typically, the encoded speech data is encoded using the G.711 codec and the encoded speech data is carried in packets in accordance with the real-time transport protocol (RTP).

Most advantageously, transcoding is performed using a variable-bit-rate codec. However, an alternative is to use one of a plurality of constant-bit-rate codecs, each one of which encodes at a different bit rate.

A method embodying this aspect of the invention typically further comprise, at a decoder, transcoding the received data to recover the encoded speech data.

In a method embodying this aspect of the invention, the encoder may determine whether a given silence threshold is breeched and if not, send a flag to the decoder to indicate the silence condition. In this condition, no encoded speech data need be sent to the decoder, thereby offering a further saving in bandwidth. During periods of silence, the encoder may send a packet to the decoder to indicate that the decoder should generate comfort noise.

From a third aspect, this invention provides a method of transmitting speech data and non-speech data between computing devices through a routing device on a network link using networking protocols comprising: a. transmitting packets containing voice data at predetermined intervals; and b. constructing a trunk packet that includes non-voice data and transmitting the trunk packet during intervals between successive voice packets. Typically, the trunk packet includes both voice and non-voice data.

This reduces the jitter attributable to packet queues to almost zero, compared to the normal minimum 40 ms of a typical outbound ADSL connection.

The method is particularly applicable to network links in which the maximum transmission unit is greater than the maximum packet size of encoded speech data. The method may involve storing all non-voice packets which are intended for transmission on the link which are received between sending intervals of speech data, and then appending them together to form a trunk packet, up to the maximum trunk packet payload size. Alternatively, large data packets can be fragmented for transmission around voice packets. In this latter case, fragments within trunk packets can be preceded by a packet ID, so that subsequent trunk packets need not necessarily contain subsequent fragments of the same packet. This allows high-priority packets to be transmitted before the remainder of a fragmented low-priority packet is sent. The ID may be either sequential or calculated from header information, and one or two bytes depending on likely load.

A method embodying this aspect of the invention can be used to implement granular QoS on a network link. If a class of traffic is only allowed a maximum bandwidth under congested conditions, then only that bandwidth of the available packet payload may be allocated to fragments from that class, assuming that there is enough data to fill the rest of the trunk packet.

Further advantage can be gained by compression of the header of the data packet(s) within the trunk prior to transmission and/or, where a Layer 2 link exists between the encoder and the decoder, using an efficient layer 2 protocol for the trunk packet itself.

Since any IP PBX is basically processor hardware and software, it is quite possible that such a device can fail. This situation is made worse if the IP PBX is located on the far side of a wide area network link, since that link too can fail. Telephone services are generally critical to any business, and failure of such services is unacceptable. To enhance the reliability of a VoIP telephony system, from a fourth aspect, this invention provides a method of transmitting speech data between an initiating computing device and a target computing device using networking protocols, in which the computing devices exchange call set-up messages to establish a speech connection, the method comprising: a. at a routing device, capturing call set-up messages from the initiating device and re-writing and duplicating them to direct them to the target device using multiple routes, b. monitoring responses received to the call set-up messages, and c. relaying to the initiating device only the response that is most favourable.

The response deemed most favourable may, for example, be that which is received most quickly, but alternative metrics could be used alternatively or additionally.

The method preferably further operates to cancel those responses that are not deemed to be the most favourable.

The re-written call set-up messages are sent out substantially simultaneously (as quickly as the hardware will allow). Alternatively, The re-written call set-up messages are sent out sequentially after a time-out. The former alternative allows the selection of the most favourable target to be based on lowest latency, while the latter reduces both network and server load.

From a fifth aspect, this invention provides a method of transmitting speech data and non-speech data between a sender and a receiver computing device on a network link comprising: a. at the receiver, i. detecting the receipt of speech data packets at an interval greater than intended; and ii. sending an information message to the sender indicating the receiving interval; b. at the sender, i. on receipt of an information message, reducing traffic sent to the receiver by an amount calculated from the receiving interval. This can allow jitter experienced by voice traffic to be reduced to a minimum.

For example, the information message may contain a percentage error to indicate the receiving interval at the receiver.

Traffic reduction may be achieved at the sender by reduction in payload size. In order that this reduction does not become irreversible, during periods when no voice traffic is present, test packets are sent by the sender to the receiver to determine a maximum payload size. Alternatively, if the receiver also contains the hardware device which controls the physical connection, then the quiescent period of the link between maximally sized packets can be used to determine the amount of unused bandwidth.

This invention also provides encoders, decoders, routers and communication devices for implementing all of the above-described methods.

An embodiment of the invention will now be described in detail, by way of example, and with reference to the accompanying drawings, in which:

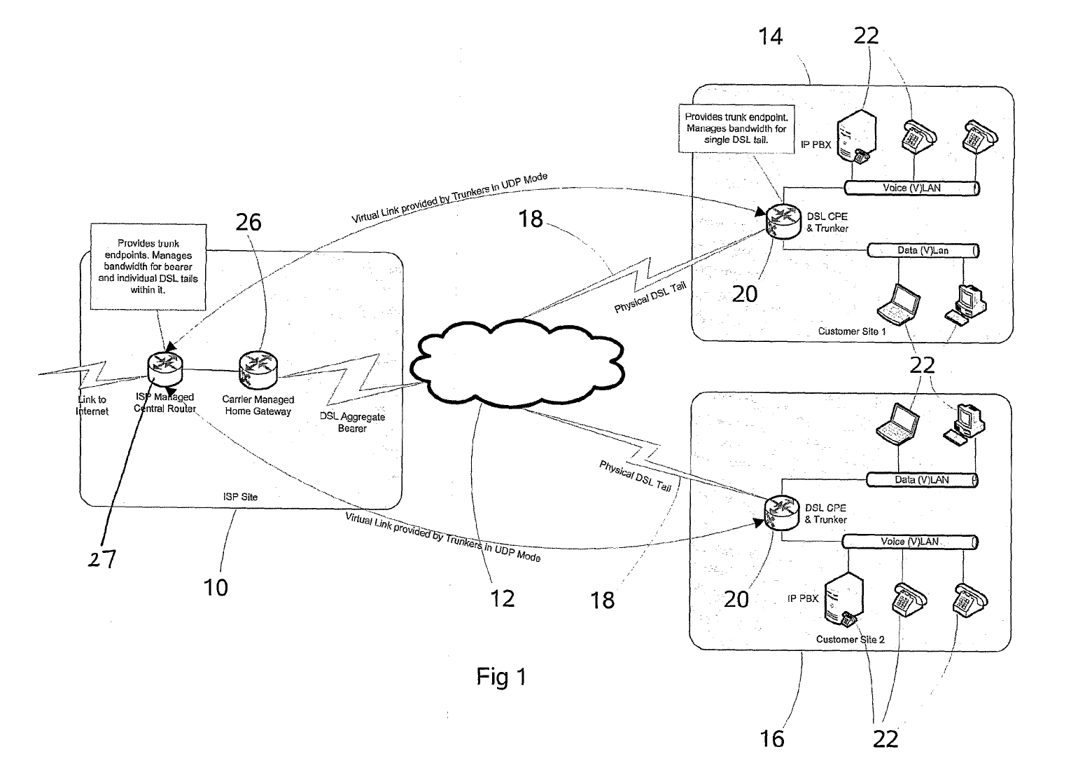

FIG. 1 shows a general layout of a sites and communication systems that implement voice over IP calling using embodiments of the invention;

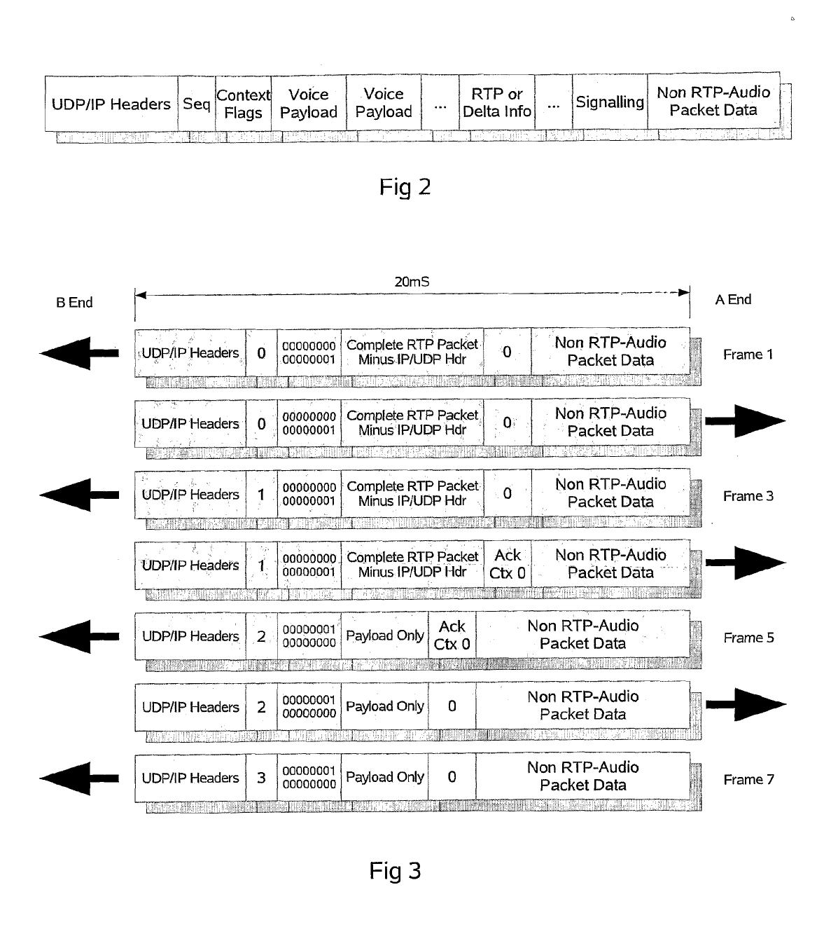

FIG. 2 illustrates an example format of a complete trunk packet;

FIG. 3 illustrates setup of a call using a method embodying the first aspect of the invention;

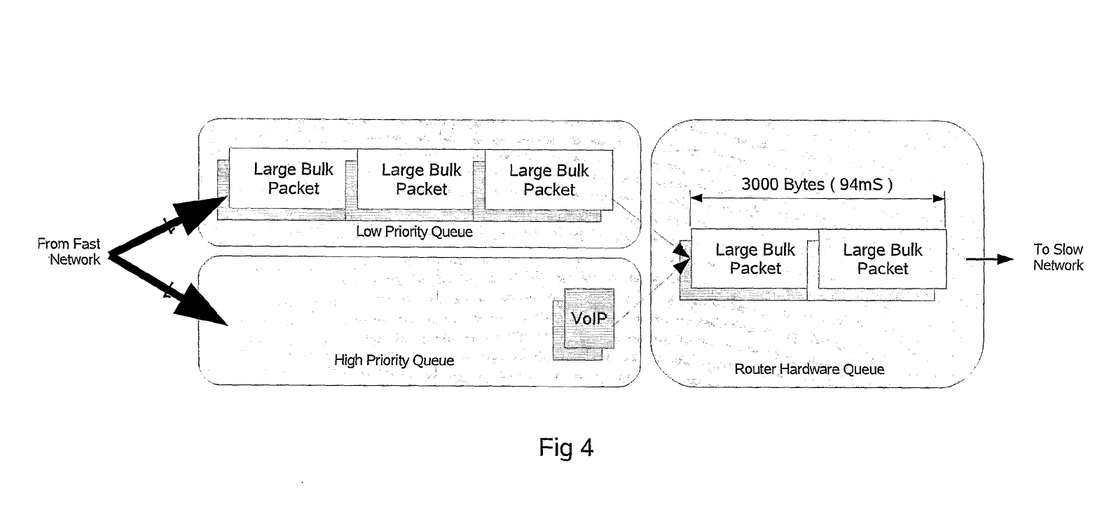

FIG. 4 illustrates conventional QoS packet queueing; and

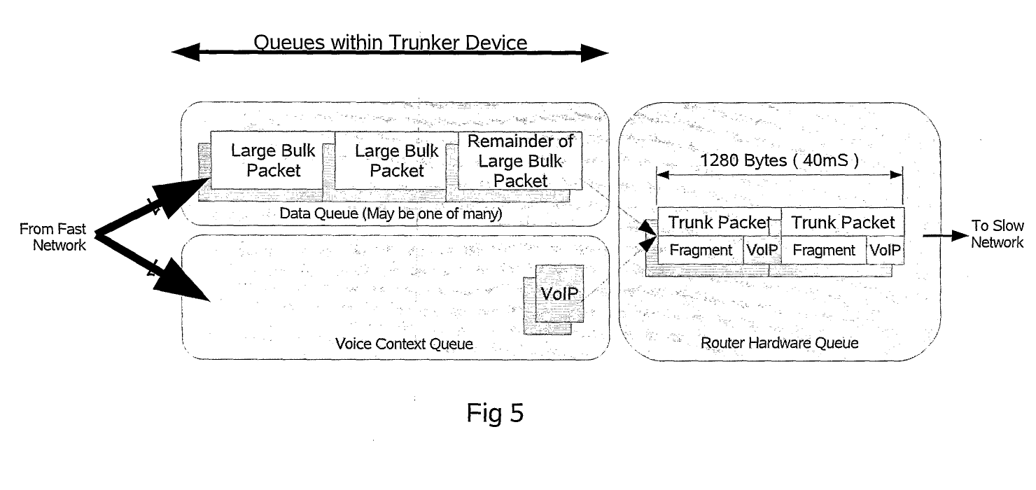

FIG. 5 illustrates provision of QoS using packet trunking and fragmentation.

The fundamental principle behind the techniques that will be presented below is that a routing device creates a point-to-point link with another such device. The link may use a virtual tunnel carried by IP/UDP or any other simple routable transport, or a real point-to-point link using Layer 2 of the seven-layer OSI data model in cases where routing is not needed between the end points. Data which passes between these points does so in packets sent at a fixed interval, which optimally matches the RTP packet interval. These payload packets have a maximum size which is equal to the amount of data which can be transmitted in the allotted interval.

The example illustrated in FIG. 1 is a complex case, whereby an Internet service provider (ISP) 10 is providing “voice optimised broadband”, by implementing embodiments of the invention, over a DSL network 12 which is supplied by a carrier, such as a national telco.

Users access the VoIP system from various client sites 14, 16 which are connected to the DSL network 12 using DSL connections 18.

The invention provides several methods and systems by which VoIP systems may be improved and optimised within the ISP 10, and these will now be described. Each client site includes a respective DSL trunker 20. Alternatively, several sites may connect to a common central trunker. These can be totally private with respect to one another, using their own IP space simply by allowing this configuration in the trunker implementation.

Any voice or data originating from clients 22 within the sites 14, 16 that is destined for the Internet is simply forwarded on from the central trunker 27. If the carrier and ISP are one and the same, then the central trunker 27 and home gateway device 26 could be the same device.

This would allow Layer 2 implementation of trunking using the L2TP tunnels typically employed internally on a DSL network.

Alternatively, customer sites could just as easily be connected to the central trunker (27) from anywhere on the Internet, though obviously there is much less control over the data path in this configuration.

If a simple point-to-point configuration is required, then there is not necessarily a need for the central trunker. Equally, trunkers could be meshed where multiple connections between multiple sites exist. However, in a typical DSL network, where the “home gateway” router is not accessible to the ISP, the central trunker is desirable due to routing and QoS implications.

### Context Based RTP Compression and Trunking

This is a method of improving on the efficiency of RTP used to transport VoIP voice calls by reducing the overhead of second and subsequent calls on a link to almost zero. The overhead can be 2.28 bits per call. This is a much lower overhead than is achieved using RTP header compression as defined in RFC2508 alone, and can be used where the two IP routers implementing the system are not separated by a single point-to-point link. The effect of this development is to combine multiple RTP streams into a single stream with minimal overhead and marrying that with a technique similar to that used in enhanced compressed RTP (E-CRTP, as defined in RFC3545) which takes advantage of this fact. By doing this, it is possible to reduce the overheads on VoIP calls significantly (especially over ATM) whilst not requiring a point-to-point link as needed by E-CRTP. Further enhancement can be achieved if a point-to-point link is available, since a layer 2 protocol without addressing information can be used for the carrier packets, saving another (frequency * 28) bytes per second.

By way of example, for a set of 14 voice calls carried conventionally between two sites using G.729 compression at a packet interval of 20mS, during each interval there would be 20 bytes of payload plus 40 bytes of headers for each call, multiplied by 14 for all of the calls. This equals 840 bytes per interval, which equals 42 kbytes per second. Additionally, there are Layer 2 overheads, which can be significant. Using this technique, the payload becomes one IP and UDP header of 28 bytes, plus one sequence byte, plus four flag bytes, and finally 20×14=280 bytes of payload. This gives a total of 313 bytes per interval which is equivalent to 15.6 kbytes per second plus much lower Layer 2 overheads.

The reduction in Layer 2 overheads is significant. As an example, if ATM AAL5 is used as a Layer 2 protocol to transport the packets, then without using embodiments of this method, the Layer 2 overheads would equate to 46 bytes for each of 14 calls, which is 644 bytes per 20 mS or 32.2 kbytes per second. With the method described above, the Layer 2 overhead reduces to 58 bytes per 20 mS or 2.9 kbytes per second.

To expand upon this, the idea is that an IP routing device, which will be referred to as the “trunker” is used to capture individual RTP packets from the network. These packets must all be transmitted at the same interval (e.g., 20 mS). Alternatively, they can be transmitted at a multiple of a convenient smaller interval (e.g., 10 mS) so that VoIP packets with intervals of any integer multiple of 10 mS can be accommodated.

All such RTP streams which are received within a trunk interval are then packaged up into a single UDP packet to a specific destination (the ‘de-trunker’) forming a virtual point-to-point link. The de-trunker then separates out all of the individual packets and re-transmits them, either at the same interval or as they arrive. A buffer of trunked packets is created in the de-trunker (which forms a jitter buffer) of a configurable length, so that jitter in the trunk transmission path is effectively converted to latency at the receiving end, with jitter at this point being zero. If a point-to-point link is available, routing of the trunked data is unnecessary. Then, rather than using a UDP packet for the trunk payload packets, a Layer 2 protocol can be assigned, eliminating the need for any routing information and saving more space.

The manner in which the RTP data is encapsulated in the trunked packet is shown in FIG. 2.

The “Seq” byte is a sequence number used to detect packet loss and mis-ordering.

The “Context Flags” field consists of a variable number of bytes in two sets. In the first set, each of the seven least-significant bits of the byte correspond to the presence of a respective fully-compressed RTP payload packet for the context indicated by the bit number. Bit 0 set means that context 0 has an equivalent RTP payload to follow, and so forth, up to bit 6. (Generally, Bit n set means that context n has an equivalent RTP payload to follow.) The most-significant bit being set indicates that another byte follows. The bits of the following byte indicate the presence of RTP payload data for contexts 7 to 13, with its most-significant bit indicating the presence of another byte in the first set. There are therefore int (max active context id/7)+1 bytes of flags in the first set.

The second set of context flags is exactly analogous to the first, except that a set bit indicates the presence of uncompressed or field update data for the appropriate context. In combination, these flags remove the need for any additional header information at all for the normal case fully-compressed RTP stream—two bytes will be added to the data stream for each additional block of up to 7 RTP streams. Field update data indicates that one or more of the IP/UDP/RTP headers which is expected to be constant or a fixed delta has changed. This would be present in addition to the compressed RTP payload data indicated by a set bit in the first set of flags. Uncompressed data means a complete RTP packet including headers, which would be present instead of the compressed RTP payload data (and hence the appropriate bit in the first set of flags would be reset).

The process applied at the trunker is as follows:

As packets pass through the trunker, potential RTP packets are identified by whatever may be available in the particular installation. Identification will usually be based on the fact that it is UDP packet on an even port, but may further be specified by examination of the source or destination address, type of service, etc. The trunking method would also normally be applied to a specific outgoing interface, which would typically be the entry point to a relatively slow network. Alternatively, packets destined for a specific network can be intercepted and encapsulated in a trunk to a specific de-trunker. It is not critical that RTP be identified with 100% accuracy, provided that no harm is done if the method is applied to a packet that does not contain RTP data.

If the source IP/port, destination IP/port, and RTP SSRC combination has not been seen before, this is deemed to belong to a new context. A context ID is assigned by first searching existing contexts in order to find one for which new packets have not been seen for an amount of time (the ‘dead time’) or if such a context does not exist, allocating the next highest available context ID. This ensures that the highest active context id (which determines the number of context flag bytes) is always as small as possible. The headers are then saved in the context state. The appropriate uncompressed data context flag will be set in the resulting trunk packet, and the entire packet as received (less any superfluous fields which can be deduced at the receiver) will be inserted into the trunk at its appropriate place. If the RTP payload type indicates a codec which may produce variable length packets, then the RTP data should be modified before transmission so that the payload type value indicates that this is the case, using some unassigned or non-audio payload type byte, in order that the receiver has a method of deducing the length of the payload data which would otherwise be removed or be required to be sent as update data.

If this is the second packet seen in a context, then delta values are saved in the context data for fields as appropriate. The time-stamp interval between the inbound RTP packets is used to determine when the next and subsequent trunk payload packets that contain data for this stream should be sent. This will continue for subsequent packets until a corresponding acknowledgement (ACK) for that context is received from the de-trunker, indicating that it has sufficient data to reconstruct the packet headers.

Once the ACK has been received, subsequent packets for which the appropriate header fields are as expected have all of their headers stripped. The appropriate RTP payload data context flag will be set and the payload of the RTP included in the trunk packet at the appropriate place in the payload. If the payload type was modified to indicate a variable length variant, then a length byte can be prepended to the payload data.

If an RTP packet is received for an active context but the fields do not appear as expected, then the RTP payload data is still placed in the trunk payload packet as normal and the compressed context payload flag bit set. Additionally, the appropriate uncompressed payload flag bit is set, and correction data placed in the uncompressed payload slot within the trunk payload. This correction data consists of a flag byte, which indicates which fields differ from their expected values, followed by the appropriate data for each field for which a flag is set.

Any data which does not conform to the expected parameters for RTP should be treated as normal data and subject to appropriate processing for same, whether this is as part of the spare capacity of the trunk payload, or separately. This includes packets that do not have the required interval (or integer multiple thereof). Normally, such packets would be appended on to the end of the trunk packet using IP or RTP header compression outside of the context structure described above, remembering that length information must be communicated where it would otherwise be removed by header compression, and that sequence information is not required since it is present in the trunk packet itself. This fits in well with the dynamic packet fragmentation technique that will be described later.

The actions of the de-trunker should be readily understood based on the above description. Once enough data is available to build the initial context, an acknowledgement is sent back to the trunker as part of the information section of the trunk payload which communicates this fact. It then reconstructs the original packet headers of compressed packets by using its context information, in a similar fashion to that described in the CRTP RFC. Reconstructed packets are then either re-trunked (if they go out of an interface or to a destination which requires it) or passed on to the network as normal. If the payload type was modified to a private type (indicating that there is a length byte or some other locally defined data carried with the payload) then this should be restored to its original type and any additional data stripped before retransmission.

An example of a flow of trunked packets during a normal call set-up phase is shown in FIG. 3. Note that this diagram also assumes that non-RTP data is carried within the trunk payload, as described below.

In relation to FIG. 3, the following points should be noted.
Sequence numbers in the second field are independent in each direction; that is to say, a sequence number is shared by packets travelling in opposite directions is of no significance.
Context numbers are also independent in each direction, so that, for example, a call which constitutes context 0 from A to B may be a different context in the other direction.
Typically, there will be a few frames similar to Frame 1 of FIG. 3 from A to B (with incrementing sequence numbers) before the acknowledgement for context 0 is received back from B to indicate that frames can be sent without RTP headers. This is due to the latency between A and B, and also the fact that B may wish to receive several frames in order to confirm that the payload is indeed RTP audio. The same applies in the opposite direction.
The signalling format could take many forms, but should include at least the ability to acknowledge that a specific context can be sent without headers. It could also be used to indicate that smaller payload packets should be sent, or that a given context has changed position. One possible saving would be to limit sequence numbers to 7 bits, and to use the spare bit in the sequence octet to indicate the presence or absence of signalling data, so that no overhead is incurred if no signalling data is present.
For each bit set in the first set of flags in the third field, there will be one voice payload. If there is also a bit set in the second set of flags in the same position, then there will be a set of update messages for the changing fields of the original RTP headers for that context, in addition to the payload data itself. If only the second set flag bit for a given context is set, there will be a complete RTP packet. The exact ordering is not important but must be agreed upon between the trunker and the detrunker.
One flag bit in each byte of Field 3 (or the chosen field for the specific implementation) indicates that there is a further flag byte present with the same meanings for the next set of contexts. An alternative would be to have a fixed number of such bytes, liberating one additional context per pair of flag bytes. This would be at the expense of wasting maybe four bytes per frame for a typical ADSL link when there are fewer than eight calls in progress based on a maximum of 24 contexts (four bytes per frame equates to 1.6 kbit/s at 20 ms assuming that all data is trunked).
   Using Bandwidth Awareness to Compress RTP Payload Data Captured from the Network.

This improvement involves capturing G.711 encoded RTP data directly from the network (as opposed to at source) and transcoding that data in such a way as to take account of the available bandwidth on an outbound link. This can be used together with a variable bit-rate coding scheme, such as that afforded by the open-source Speex codec, and adjusting the coding parameters based on the available bandwidth and number of calls in progress. It can also be used, for example, to step shift from G.711 to GSM to G.729 depending on available bandwidth and call quality. This is especially useful if the link is switched to a backup (slower) one, for example as the result of a failure. It would allow all calls to continue, albeit at a reduced fidelity. Using known methods, all calls would typically fail. Another advantage is that a wide range of codecs can be used on a network, regardless of support within the VoIP devices deployed.

This technique will now be described in further detail.

For RTP payload data which is encoded in G.711 format, it is possible to capture packets and transcode them to a different format on the fly. Since all packets destined for the far end of a slow wide-area network link pass through a routing device, it is possible to determine exactly how much bandwidth is used on that link by high priority RTP voice packets.

Combining these two facts, and using a variable-bit-rate compressor such as Speex, it is possible to vary the bit-rate of the encoding process so as to take into account the amount of free bandwidth on the link, thus giving the highest quality speech possible (rather than the quality of each stream being limited by the maximum number of streams that could be carried if needed). Without using a variable-bit-rate codec, it is possible to switch between different codecs to achieve a similar effect, though the change may be very noticeable at the receiving end of the link.

A routing device at the receiving end of the real or virtual point-to-point link can then decompress the payload data in using corresponding techniques. Therefore, it is not necessary for any of the call set-up information to be modified or for support of the relevant codecs to be present in either of the endpoints of the data stream. This is only desirable, however, where it is known that the conversation will not be transcoded subsequently during its journey to its destination, since the quality will degrade if lossy compression methods are used, as is typically the case.

If there is to be further transcoding in the path, then it is also possible to examine the call set-up packets in order to determine whether a given codec is supported at one end of the link, and to indicate acceptance of such even if the telephony device itself does not support it. In this way, it is possible to use Speex (or other) codec where one end device does not support it, with the routing devices transcoding packets from one end of the link. (So, for example, an IP PBX that supports Speex, but no proprietary CODECS, could be used with IP phones which only support G.711 and G.729.)

Additional functionality can be incorporated transparently. For example, if the stream was originally G.711 encoded, the trunker can determine whether a given silence threshold is breeched. If not, it can simply send a flag to indicate the condition rather than sending any payload data at all. The receiving trunk box can generate a comfort noise packet and send it on, thus transparently implementing silence suppression where one or other of the endpoint devices does not support it.

### Dynamic and Transparent Packet Fragmentation and Reassembly Based on RTP Interval to Reduce VoIP Latency and Jitter.

The trunking mechanism described above can be used to transport all data on a virtual point-to-point link giving context-based IP header compression, only sending non-voice traffic when there is room to do so. This reduces the jitter attributable to packet queues to almost zero, compared to the normal minimum 40 ms of an outbound ADSL connection. It is more efficient, convenient and effective than the alternative methods of reducing the MTU of the link, or using PPP multilink fragmentation and interleaving. Effectively, because it is known when a VoIP packet is to be transmitted, the method can send just as much data as will fit before the next VoIP cell is due. The fragmentation of the data packets is totally transparent to the endpoints of the communication. Standard quality-of-service (QoS) queueing mechanisms can be employed which allocate portions of the trunk payload packet to different queues, or the remaining space can be multiplexed amongst several flows. Given that the only traffic travelling on the bottleneck of the link between trunking devices should be the trunk payload packets themselves, the effect of this is dramatically better than the more normal best effort QoS schemes alone.

For a low bandwidth link, at the normal voice packet interval of 20 ms, the maximum packet size which can be transmitted at this interval is much less than the 1500 bytes which is the maximum transmission unit (MTU) on common networks. This has the consequence that if a bulk data transfer is happening which uses 1500-byte packets, then regardless of any packet prioritisation that takes place, multiple voice packets could end up being queued behind a currently in progress bulk packet.

As an example, take a link of 256 kbit/s (a common outbound speed of ADSL in the UK). If a 1500 byte packet (which has a size of 1528 bytes with headers) just starts to be clocked out of an interface at the point when a 20 ms interval RTP packet arrives, then another such RTP packet will have arrived before the original one can be sent. The first RTP packet will be sent approximately 48 ms late, followed immediately by the queued RTP packet, and then (assuming no traffic is being clocked out at the time) the next RTP packet will go out on time. This gives a jitter of 47 ms. Worse, quite often routers have a hardware buffer of at least two packets, meaning that the problem could actually be doubled. This is illustrated in FIG. 4.

Packets coming in from the fast network are assigned to queues which are allowed to be sent at different rates or with different priorities. Since this network is typically 100 Mbit/s, many large bulk packets can arrive in-between the smaller VoIP packets, and even though those smaller packets will be sent to the hardware first, there will almost certainly be a full hardware buffer which is already transmitting its payload and this process can not be interrupted.

There are two ways around this which are normally employed:
1. The MTU on an interface is reduced in order to limit the maximum size of a packet that could possibly be “holding up” an RTP packet. This can results in lower efficiency due to the increase in IP header data relative to payload, and does not eliminate all significant jitter. It also increases the number of packets per second seen by the network.
2. PPP Multilink fragmenting and interleaving can be used. This requires a point-to-point link and control of the routers at each end (which is often not the case with DSL).
In addition, a significant variable delay can still occur, especially if the traffic is transmitted over several such links, such as in a hub and spoke network where site-to-site communication is required.

The method described here can be used over any virtual point-to-point link, and works especially well when combined with the voice over IP trunking mentioned described above. This is because if VoIP traffic definitely will be present on a given link, then there are no overheads. In addition, IP header compression as defined in RFC1144 and similar schemes such as payload compression can be used across the entire link, which may not otherwise be possible.

The scheme makes the assumption that VoIP traffic should have absolute priority on a network, and that reduced jitter incurred by such traffic can be substituted for a small (maximum 20 ms in the normal case) additional latency for other traffic.

UDP packets are sent out of a network interface to a certain IP address and port. The remote target could be the de-trunker described previously. Alternatively, the packet could be sent using a Layer 2 link if a real point-to-point link which supports it is present, to avoid the UDP/IP overhead. Those packets are the only ones sent out over the slow segment of the link between the trunker and de-trunker, so in that way the maximum size of each packet can be calculated. For example, if a link is 256 kb/s, it should be possible to send out a 640-byte packet every 20 ms without creating queues in any other device along the path. In practice, the calculation can be more complicated than that, depending on the low-level protocols used—for example PPP over ATM as used in UK DSL connections. However, these calculations are easily understood for a given technology and will not therefore be described here.

The routing device then simply stores all non-voice packets which are intended for transmission on the link which are received between sending intervals, and then appends them together with voice data encoded as previously described to form a trunk packet, up to the maximum trunk packet payload size already calculated. Modified IP header compression (excluding the length field; similar to the RTP compression described above) can be used on the packets in order to increase efficiency. In the simple case, if a packet is too big to fit in the remaining space, then as much as possible is included. The de-trunker can work out how much is included from the link layer or IP header packet length. The next sequenced trunk payload packet would be assumed to contain the rest of the fragmented packet (or as much of it as possible) and so on. If there is space left in the payload packet, then another data packet (or fragment of a packet) can be included and so on. In this way, it is not necessary to store any additional length information other than that contained in the IP header of the packets and the length of the trunk payload packet itself. The difference that this makes can be seen from FIG. 5.

Since the trunking device is only sending data at a rate permitted by the slow network, no software queues build up within the router, though of course the trunking and routing device could be one and the same physical piece of hardware. Trunk packets are only sent at known intervals, so that any voice packets that are also to be sent can be incorporated into each one, and so can be sent at the optimum time instead of having to wait until the network is quiescent. Further, large data packets can be arbitrarily fragmented and reassembled at the receiving end, in order to make the most efficient use of space within the trunk packets themselves.

To give more granular control over quality of service for non voice packets, trunk packets and fragments can be preceded by a packet ID, so that subsequent trunk packets need not necessarily contain subsequent fragments of the same packet. This allows high-priority packets to be transmitted before the remainder of a fragmented low-priority packet is sent. The IDs could be either sequential numerical values or are determined algorithmically from header information. Another alternative would be to have multiple queues which can be assigned a percentage of the available space. In this instance, only a length field for each queue except one would need to be included in the data stream, indicating the number of octets allocated to each queue in the data stream. Each individual queue can then be treated as in the simple case above. Note that there is no need to send length information for the final queue, since this can be calculated from the entire trunk packet length and the lengths of the other queues. Also, these lengths need not be whole-octet fields and can be packed and padded as appropriate—11-bit fields are appropriate for most instances, though implementation-specific variations (such as using 8-bit fields and multiplying by two, limiting each queue to 512 bytes and even padding) could obviously be used.

Combined with the method of trunking RTP voice calls described above, this represents no loss of efficiency of the link, providing that voice traffic is actually present on the link. It ensures that VoIP packets are placed at the head of the trunk, and hence subject to minimal delay. The interval chosen to send out packets need not be the same as the RTP interval, though the RTP interval should be integrally divisible by it. In cases where these intervals are not the same, then efficiency does suffer due to the additional UDP/IP headers in the trunk packets unless IP header compression or Layer 2 transport is used for those.

There is the option of disabling trunking automatically if no RTP audio packets are present, and re-enabling it on first initiation of a new call. Note, too, that if ATM is used in the underlying transport, the the fact that all packets are sent in one trunk packet saves 8 bytes per packet (the ATM trailer).

Queueing mechanisms to introduce further QoS granularity can easily be incorporated into this system. For example, if a class of traffic is only allowed ten percent of the link bandwidth under congested conditions, then only ten percent of the available packet payload is allocated to fragments from this class, assuming that there is enough data to fill the rest of the packet. In this case, the length of any packet fragments would also have to be stored within the data stream, since they would not necessarily be the final data in a trunk packet. It is preferable to limit the voice calls themselves to a certain number of contexts, since that data is critical and it-would be undesirable to disrupt calls already in progress.

If there is no data to send in a given interval, a packet with an empty payload might still be sent. This would allow the receiver to determine very quickly if a given remote destination is unreachable either because of a link failure or a device failure, so that an alternative route to the remote destination can be used, if appropriate. This would allow a backup link to be brought into service quickly enough to not adversely affect any voice calls in progress. Further, if all payload packets were padded to the same length, jitter due to hardware transmission delays would not be introduced. However, if a data transfer charging model is in effect, then this may not be desirable, since it would incur charges for data that carries no useful payload.

### Dynamic Re-Writing of SIP Messages to Provide Automatic Fail-Over and Load Balancing of SIP Servers.

This method involves capturing SIP call set-up messages and re-writing and duplicating them to direct them to multiple servers. The response is monitored to determine which server responds most quickly and allowing only the reply received back from that server to be relayed to the source device. Alternatively or additionally, a time-out can be applied before re-writing and sending to a backup SIP server which may be over a backup IP link.

To enhance the reliability of a VoIP system, a routing device is present in a network which captures all traffic between an IP PBX and its connected devices. The routing device can re-write the call control messages (e.g. those that use the SIP protocol) in order to re-direct communications transparently. The originator of a call that has been set up using the SIP protocol could actually be communicating with a different SIP server than that for which it is configured.

Implementation of this aspect of the invention can be used to produce several benefits, as will now be described.

When the routing device sees a call set-up request, for example, as indicated by a SIP INVITE packet, then it can send out multiple such messages to different servers. The server that responds most quickly would be allowed to communicate with the original requester, with the routing device re-writing any control messages accordingly. The multiple servers could also be a single PBX with multiple addresses which are routed over different links. It should also cancel any calls which would otherwise have been created by the other servers. This process would provide automatic fail-over in the case that a server (or link to that server) fails, and also select the route with the lowest latency.

Rather than sending out multiple requests simultaneously, the routing device may try several devices in turn after a time-out. The later alternative does not allow the selection of a remote server to be based on lowest latency, but reduces both network and server load. Also, if the primary server fails, a back-up link (such as an ISDN dial-up link) could automatically be brought into service before another connection is attempted. These techniques could equally apply to any call set-up protocol other than SIP.

### Dynamic Sizing of Trunk Payload Packets.

Once a connection to carry a VoIP call is set up on a link, it is possible for the receiving trunk device to determine if the received packets are too big or small, and to signal the transmitter to adjust its payload size accordingly.

On a private network, given that an interval-based trunk system is in place and that the trunk payload packets are the only ones that traverse the bottleneck between two sites, it is possible to control the quality of service experienced by packets. However, in a typical service provider network, there are shared portions of links which have an overall bandwidth restriction which is contended amongst several such connections.

If the real effect of such contention is to reduce the available bandwidth on a link, then it is possible to detect this at the receiving trunker, since it will receive packets at greater than the configured packet interval when large payload packets are sent. If this happens consistently, the receiving trunker can send an information message back to the sender giving the percentage error, and the sender can reduce its payload size accordingly, ensuring that jitter experienced by voice traffic is reduced to a minimum.

During periods when no voice traffic is present, larger test packets can be sent so that the maximum payload size can again be ascertained. This method can also be used to scale the packets to the available bandwidth on a link from scratch by utilising standard algorithms known to those skilled in the technical fields. Alternatively, in the case where the receiving device also has access to the physical line protocol, the quiescent period between maximally-sized packets or empty ATM cells can be used to determine whether the payload size can be increased.

Although each of the embodiments described above refer to communications over a point-to-point link, real or virtual, a service provider could provide a central trunking server which acts as one end point of each link in a typical star configuration network (such as DSL broadband). In this scenario, the central box either breaks out packets destined for the rest of the world, or re-trunks those that are for other users of the service. It is also straightforward to encrypt trunk payload packets using standard methods such as transporting them over an IPSEC link if desired, or to assign IP addressing based on groups of remote sites. This allows multiple remote sites to share IP addressing schemes, providing that the different groups are not allowed to intercommunicate.

### Explanation of Abbreviations and List of RFCs

AAL5: ATM Adaptation Layer 5, which adapts multi-cell higher layer PDUs into ATM with minimal error checking and no error detection.

ATM: Asynchronous Transfer Mode; a cell relay network protocol which encodes data traffic into small, fixed-sized (53 byte; 48 bytes of data and 5 bytes of header information) cells instead of variable-sized packets.

CODECS: This is a contraction of the words Coder-Decoder. It describes a process by which data is encoded at one end of a transmission link and then decoded upon reception. This process usually, but not always, involves compressing and decompressing the signal in order to reduce bandwidth on the link.

G.711: This is a speech codec widely used for encoding and decoding voice traffic on a digital network. It provides a method of encoding raw twelve-bit audio samples in just eight bits, though the sample rate is unaffected. This is performed using a non-linear analogue-to-digital conversion, where more sample levels are present in the lower signal amplitude range than at higher ones. Since the encoding takes place at the A/D converter stage, voice transmitted using G.711 is effectively the base line and can be thought of as uncompressed.

G.729 is an audio data compression algorithm for voice that compresses voice audio in packets of 10 ms or an integral multiple thereof.

MTU: Maximum Transmission Unit (MTU); the size in bytes of the largest packet that a given layer of a communications protocol can pass onwards.

PBX: Private Branch eXchange is a telephone exchange that is owned by a private business, as opposed to one owned by a common carrier or by a telephone company.

RTP: Real-time transport protocol. A transport protocol for real-time applications, defined in RFC 3550.

RFC 1144—Compressing TCP/IP headers for low-speed serial links.

RFC 2508—Compressing IP/UDP/RTP Headers for Low-Speed Serial Links.

SIP: Session Initiation Protocol; an IETF standard, one of the principal signalling protocols for VoIP.

SSRC: The SSRC is a field within an RTP header, and in various fields of RTCP packets, that contains an identifier which is a 32-bit number that must be globally unique within an RTP session.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A method of transmitting speech data and non-speech data between computing devices through a routing device on a network link using networking protocols comprising:
a. transmitting packets containing voice data at predetermined intervals; and
b. constructing a trunk packet comprising non-voice data and transmitting the trunk packet during intervals between successive voice packets.

20. A method according to claim 19 in which the maximum transmission unit is greater than the maximum packet size of encoded speech data.

21. A method according to claim 20 in which the trunk packet includes voice data.

22. A method according to claim 20 comprising storing all non-voice packets which are intended for transmission on the link which are received between sending intervals of speech data, and then appends them together to form a trunk packet, up to a maximum trunk packet payload size.

23. A method according to claim 20 comprising storing all non-voice packets which are intended for transmission on the link which are received between sending intervals of speech data, and then appends them together to form a trunk packet and fragmenting the trunk packet for transmission.

24. A method according to claim 20 in which trunk packets and fragments are preceded by a packet ID, whereby subsequent trunk packets need not contain subsequent fragments of the same packet.

25. A method according to claim 24 in which the packet IDs are sequential numerical values.

26. A method according to claim 24 in which the packet IDs are determined algorithmically from header information.

27. A method according to claim 20 in which, a class of traffic is only allowed a maximum bandwidth under congested conditions, then only that bandwidth of the available packet payload is allocated to fragments from that class.

28. A method according to claim 27 in which additional bandwidth can be allocated to the class if there is no additional data to be transmitted in the trunk packet.

29. A method according to claim 20 further comprising applying header compression to data packets within the trunk packet.

30. A method according to claim 20 further comprising applying data compression to data within non-voice data packets within the trunk packet.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A router for use on a network link for transmitting speech data and non-speech data between computing devices using networking protocols, the router operative to construct a trunk packet including non-voice data and transmitting the trunk packet during intervals between successive voice packets.

44. (canceled)

45. (canceled)
